(19) United States
(12) Patent Application Publication
(10) Pub. No.: US 2005/0273604 A1
(43) Pub. Date: Dec. 8, 2005

(54) [MOBILE PHONE WITH FILE ENCRYPTION FUNCTION AND METHOD OF ENCRYPTING/DECRYPTING FILE THEREOF]

(76) Inventors: Chengshing Lai, Taipei County (TW); Qinghua Li, Nanking (CN); Xiaolong Fan, Nanking (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,895

(22) Filed: Jun. 4, 2004

(51) Int. Cl. H04L 9/00

(52) U.S. Cl. 713/165

(57) ABSTRACT

A mobile phone with file encryption function and method for encrypting file thereof are provided. The main unit of the mobile phone includes an encryption software. The second encryption software encrypts/decrypts the file stored in the computer based on a key. The method for encrypting file comprises: (a) establishing a transmission channel between the mobile phone and the computer; (b) sending the first file from said computer to the mobile phone; (c) encrypting/decrypting the first file based on a key to obtain a second file in the mobile phone; and (d) sending the second file from the mobile phone to the computer. Of course, the first file can be divided into a plurality of first packets in the computer. Then, the first packets can be sent to the mobile phone, encrypted/decrypted in the mobile phone, and sent back to the computer until all of the first packets have been encrypted/decrypted to obtain the second packets. Finally, the second packets can be combined to obtain the second file in the computer.

### BACKGROUND OF INVENTION

1. Field of the Invention

This invention generally relates to a mobile phone with file encryption function and method of encrypting file thereof, and more particularly to a mobile phone capable of encrypting/decrypting the files stored in the computer.

2. Description of Related Art

As the information technology advances, the electronic devices such as computer, personal digital assistant (PDA), and mobile phone are ubiquitous. People rely on the computers more than before. Most video/audio information, text files, programs and personal information are stored in the computers. Among those files in the computers, some of them relate to person's privacy or confidential information. Hence, more and more users would like to protect those files.

Currently, a variety of encryption devices can encrypt/decrypt the files in the computer by connecting the computer. However, those encryption devices only provide the encryption/decryption function. To provide security and flexibility, those encryption devices have to be kept in a different place or be carried with the person, which makes the user bear more burden. Further, the user of the traditional encryption device has to memorize a password. When encrypting/decrypting the files in the computer, the user has to input the password first. If the user forgets the password, the traditional encryption device cannot encrypt/decrypt the files in the computer, which may cause a serious loss.

### SUMMARY OF INVENTION

The present invention is directed to a mobile phone with file encryption function and method of encrypting/decrypting the file thereof. The mobile phone, according to an embodiment of the present invention, is capable of encrypting/decrypting the files in the computer, therefore the need of an additional encryption device or memorizing a password can be effectively avoided.

The present invention is directed to a mobile phone with file encryption function, for encrypting/decrypting a file stored in a computer. According to an embodiment of the present invention, the computer includes a first encryption software and connected to the mobile phone via a transmission channel.

According to an embodiment of the present invention, the mobile phone comprises a main unit, a transmission channel interface, a mobile communication transceiver coupled to the main unit and human machine interface coupled to the main unit. The main unit comprises a second encryption software, wherein the second encryption software corresponds to the first encryption software of the computer. The second encryption software is adapted for encrypting/decrypting the file stored in the computer based on a key. The transmission channel interface is adapted for connecting the computer via the transmission channel. The human machine interface is adapted for inputting a command and displaying information.

In an embodiment of the present invention, the mobile phone includes an identification code corresponding to the key. The transmission channel includes a wired transmission channel or a wireless transmission channel.

In an embodiment of the present invention, the human machine interface includes an output device coupled to the main unit; and an input device coupled to the main unit. The ouptu device is adapted for displaying the information, and the input device is adapted for inputting the command. The human machine interface can be a touch screen or other well known human machine interfaces.

The present invention is directed to a method of encrypting/decrypting file stored in a computer via a mobile phone.

The method of encrypting the file, according to an embodiment of the present invention, comprises: (a) establishing a transmission channel between the mobile phone and the computer; (b) sending a first file from the computer to the mobile phone; (c) encrypting/decrypting the first file based on a key to obtain a second file in the mobile phone; and (d) sending the second file from the mobile phone to the computer.

The present invention is also directed to a second method of encrypting a file stored in a computer via a mobile phone.

The method of encrypting/decrypting the file, according to another embodiment of the present invention, comprises: (a) establishing a transmission channel between the mobile phone and the computer; (b) dividing a first file into a plurality of first packets in the computer; (c) encrypting/decrypting the plurality of first packets to obtain a plurality of second packets, wherein the step of encrypting/decrypting the plurality of first packets includes (c1) sending the plurality of first packets from the computer to the mobile phone; (c2) encrypting/decrypting one of the plurality of first packets based on a key to obtain a second packet in the mobile phone; and (c3) sending the second packet from the mobile phone to the computer, (d) repeating the step of encrypting/decrypting one of the plurality of first packets to obtain one of the plurality of second packets until the plurality of first packets have been encrypted/decrypted to obtain the plurality of second packets; and (e) combining the plurality of second packets to obtain a second file in the computer.

In addition, in the above two embodiments of the present invention, the mobile phone comprises an identification code corresponding to the key. The transmission channel includes a wired transmission channel or a wireless transmission channel.

In light of the above, the mobile phone with file encryption function and method of encrypting/decrypting file thereof, according to an embodiment of the present invention, besides the mobile communication function of the mobile phone, the mobile phone also comprises the file encryption function so as to expand the function of the mobile phone. Further, the user need not memorize the password and can use the identification code of the mobile phone to encrypt/decrypt the files so that the mobile phone user can encrypt/decrypt the files as he needs.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a block diagram of a mobile phone with file encryption function in accordance with an embodiment of the present invention.

FIG. 2 is a block diagram of a computer and a mobile phone with file encryption function in accordance with an embodiment of the present invention.

FIG. 3 is a flow chart illustrating a method of encrypting files in accordance with an embodiment of the present invention.

FIG. 4 is a flow chart illustrating a method of encrypting files in accordance with another embodiment of the present invention.

### DETAILED DESCRIPTION

FIG. 1 is a block diagram of a mobile phone with file encryption function in accordance with an embodiment of the present invention. Referring to FIG. 1, the mobile phone 100 includes a main unit 100, a mobile communication transceiver 120 and a human machine interface 130. The mobile communication transceiver 120 is coupled to the main unit 110 and is adapted for providing the basic mobile communication function of the mobile phone 100. The man machine interface 130 is coupled to the main unit 110 and is adapted for inputting the command and displaying the information.

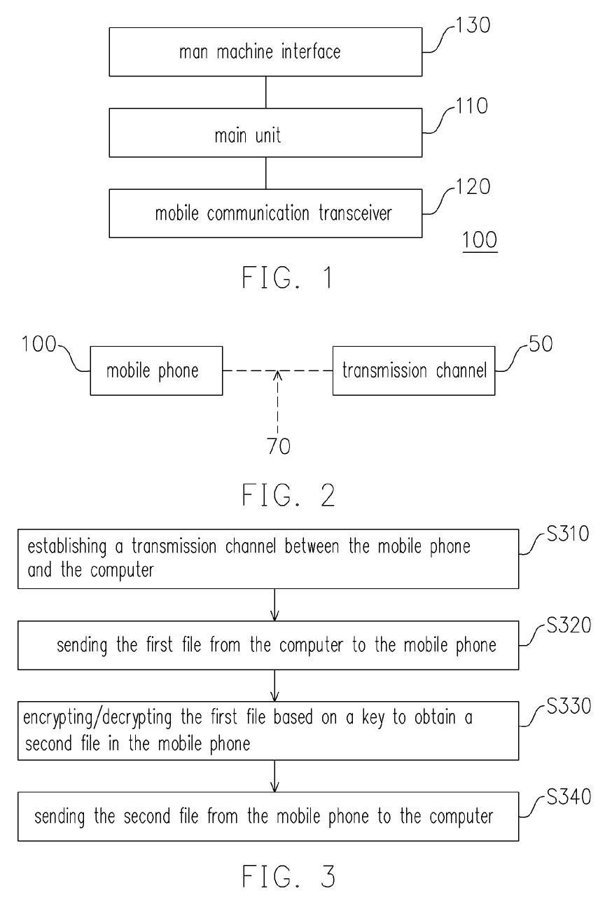

FIG. 2 is a block diagram of a computer and a mobile phone with file encryption function in accordance with an embodiment of the present invention. Referring to FIG. 2, the mobile phone 100 further comprises a transmission channel interface (not shown) that is coupled to the main unit 110 in FIG. 1. The transmission channel interface connects the mobile phone 100 to the computer 50 via the transmission channel. The mobile phone 100 can encrypt/decrypt the file in stored in the computer 50. The computer 50 comprises a first encryption software. The main unit 110 comprises a second encryption software. The second encryption software corresponds to the first encryption software. In addition, the second encryption software encrypts/decrypts the file in stored in the computer 50 based on a key.

Further, the mobile phone 100 comprises an identification code corresponding to the key. Because generally each mobile phone has a unique identification code, the user need not memorize any password and the file can be encrypted/decrypted based on the key corresponding to the identification code. Hence, the user need not worry about forgetting the password when he wants to encrypt/decrypt the file in stored in the computer 50, especially under an exigent circumstance, which prevents the user form suffering from serious loss if the file cannot be encrypted/decrypted.

In addition, the transmission channel 70 between the computer 50 and the mobile phone 100, for example, can be a wired transmission channel. The computer 50 is connected to the mobile phone 100 via a transmission cable. The port of the transmission cable may be RS232 port, USB port, or Parallel port, etc.

Of course, the transmission channel 70 between the computer 50 and the mobile phone 100 can also be a wireless transmission channel. The computer 50, for example, comprises a first wireless transceiver and the mobile phone 100 comprises a second transceiver. The wireless transmission mediums such as the infrared rays or radio waves can be used as the wireless transmission channel 70. The wireless transmission protocols such as Bluetooth or Wireless Local Area Network (WLAN) can be used to the wireless transmission channel 70.

In addition, the human machine interface 130 of FIG. 1, for example, includes an image output device and a command input device. The image output device is coupled to the main unit 110 and is adapted for displaying the information for the user to read. The command input device is coupled to the main unit 110 and is adapted for inputting the command to the mobile phone by the user. Of course, the human machine interface can also be a touch screen providing an image output function and a command input function.

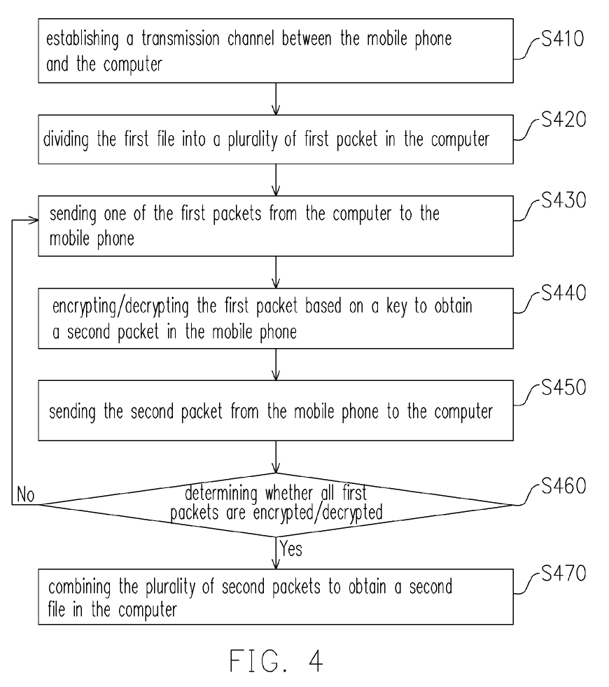

FIG. 3 is a flow chart illustrating a method of encrypting files in accordance with an embodiment of the present invention. The method of encrypting file in accordance with an embodiment of the present invention is suitable for encrypting/decrypting a first file stored in a computer via a mobile phone. The detailed description of the mobile phone has been described above and will not be repeated hereinafter.

Referring to FIG. 3, in step S310, a transmission channel between the mobile phone and the computer is established. The transmission channel, as described above, includes a wired transmission channel or a wireless transmission channel. The user selects the first file by using the first software on the computer via the software interface.

Then the method proceeds to step S320, where the first file from the computer is sent to the mobile phone. Then the method proceeds to step S330, where the first file is encrypted/decrypted based on a key to obtain a second file in the mobile phone. Finally, in step S340, the second file from the mobile phone is sent to the computer. In step S330, the user runs the second encryption software on the mobile phone. The second encryption software encrypts/decrypts the first file based on the key.

To prevent the size of the file exceeding the memory space of the mobile phone so that the above embodiment cannot work, another embodiment of the present invention is proposed as follows with reference to FIG. 4. The method for encrypting file in accordance with this embodiment of the present invention is suitable for encrypting/decrypting a first file stored in a computer via a mobile phone.

Referring to FIG. 4, in step S410, a transmission channel between the mobile phone and the computer is established. In step S420, the first file is divided into a plurality of first packets in the computer. The transmission channel, as described above, includes a wired transmission channel or a wireless transmission channel. The user selects the first file using the first software on the computer via the software interface.

Then the method proceeds to step S430, where one of the first packets from the computer is sent to the mobile phone. Then the method proceeds to step S440, where the first packet is encrypted/decrypted based on a key to obtain a second packet in the mobile phone. In step S440, the user may run the second encryption software on the mobile phone. The second encryption software encrypts/decrypts the first packet based on the key to obtain the second packet. Then in step S450, the second packet is sent from the mobile phone to the computer.

After completing the step S450, the method proceeds to step S460, where whether all of the first packets are encrypted/decrypted is determined. If not, then the method returns to step S430. Otherwise, the method proceeds to step S470, where the plurality of second packets are combined to obtain a second file in the computer. The step S470 may be performed by the first encryption software in the computer.

In light of the above, the mobile phone with file encryption function and method of encrypting file thereof, according to the present invention have at least the following advantages:
1. The present invention integrates the mobile communication and the file encryption functions so as to create the added value of the mobile phone.
2. The present invention allows encryption/decryption of the important files whereby the loss of the confidential file can be effectively avoided.
3. The present invention is capable of reducing the burden of carrying an addition device for encryption/decryption of files because the mobile phone is most commonly by people nowadays.
4. Because the key for encrypting/decrypting the file corresponds to the identification code of the mobile phone, the user need not memorize any password, therefore the loss due to forgetting of the password can be effectively avoided.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A mobile phone with file encryption function, for encrypting/decrypting a file stored in a computer including a first encryption software, comprising:
a main unit, including a second encryption software to said first encryption software, said second encryption software adapted for encrypting/decrypting said file stored in said computer based on a key;
a transmission channel interface, coupled to said main unit and adapted for connecting the computer via a transmission channel;
a mobile communication transceiver, coupled to said main unit; and
a human machine interface, coupled to said main unit and adapted for inputting a command and displaying information.

2. The mobile phone of claim 1, further comprising an identification code corresponding to said key.

3. The mobile phone of claim 1, wherein said transmission channel includes a wired transmission channel.

4. The mobile phone of claim 1, wherein said transmission channel includes a wireless transmission channel.

5. The mobile phone of claim 1, wherein the human machine interface includes:
an output device, coupled to said main unit, for displaying said information; and
an input device, coupled to said main unit, for inputting said command.

6. The mobile phone of claim 1, wherein said human machine interface includes a touch screen.

7. A method of encrypting/decrypting a file stored in a computer via a mobile phone, comprising:
establishing a transmission channel between said mobile phone and said computer;
sending a first file stored in said computer to said mobile phone;
encrypting/decrypting said first file based on a key to obtain a second file in said mobile phone; and
sending said second file from said mobile phone to said computer.

8. The method of claim 7, wherein said mobile phone comprises an identification code corresponding to said key.

9. The method of claim 7, wherein said transmission channel includes a wired transmission channel.

10. The method of claim 7, wherein said transmission channel includes a wireless transmission channel.

11. A method of encrypting/decrypting a file stored in a computer via a mobile phone, comprising:
establishing a transmission channel between said mobile phone and said computer;
dividing a first file stored in said computer into a plurality of first packets in said computer;
encrypting/decrypting said plurality of first packets, said step of encrypting/decrypting said plurality of first packets including:
sending one of said first packets from said computer to said mobile phone;
encrypting/decrypting said first packet based on a key to obtain a second packet in said mobile phone;
sending said second packet from said mobile phone to said computer;
repeating said step of encrypting/decrypting one of said plurality of first packets until said plurality of first packets have been encrypted/decrypted; and
combining said plurality of second packets to obtain a second file in said computer.

12. The method of claim 11, wherein said mobile phone comprises an identification code corresponding to said key.

13. The method of claim 11, wherein said transmission channel includes a wired transmission channel.

14. The method of claim 11, wherein said transmission channel includes a wireless transmission channel.
